(19) United States
(12) Patent Application Publication
(10) Pub. No.: US 2007/0280108 A1
(43) Pub. Date: Dec. 6, 2007

(54) METHOD AND SYSTEM FOR MEASURING PACKET DELIVERY QUALITY

(75) Inventor: Akira Sakurai, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/755,065

(22) Filed: May 30, 2007

(30) Foreign Application Priority Data
May 31, 2006 (JP) 2006-150776

(51) Int. Cl. H04L 12/26

(52) U.S. Cl. 370/232

(57) ABSTRACT

A system measures delivery quality of data packets transmitting from a communication device to at least one communication terminal through a multicast network. The system includes a communication section for periodically transmitting a first packet to a communication terminal and receiving a second packet in response to the first packet from the communication terminal. The second packet includes delivery quality information. The system further includes a measuring section for measuring the delivery quality of data packets based on the delivery quality information.

### BACKGROUND OF THE INVENTION

1. Field of the Invention

This application is based upon and claims the benefit of priority from Japanese Patent Application No. 2006-150776, filed on May 31, 2006, the disclosure of which is incorporated herein in its entirety by reference.

The present invention relates to a technology for measuring the quality of packet delivery and, more particularly, to a method and system for measuring the quality of packet delivery over a multicast network, as well as to communication equipment using the same.

2. Description of the Related Art

In recent years, with the improvement of the Internet and broadband technologies, the distribution of multimedia content over communication networks is becoming popular, and the full proliferation of streaming delivery is in particular expected. This streaming delivery is a technology by which when voice or video is delivered, a receiving terminal does not reproduce the voice or video after it has received the whole file, but sequentially reproduces the voice or video as it is receiving packets. The streaming delivery is suitable for the delivery of content of which real-time characteristics are required, such as a live broadcasting or the redelivery of a TV broadcast program.

For the communication protocols that implement this streaming delivery and its quality management, used are RTP (Real-time Transport Protocol) and RTCP (RTP Control Protocol), specified by the IETF (Internet Engineering Task Force) (for example, see “RTP: A Transport Protocol for Real-Time Applications,” RFC 3550 (July 2003), sections 5 and 6.) RTP is a data transport protocol for providing the real-time delivery of media such as voice and video. RTCP is a control protocol for allowing a sender and a receiver on a RTP session to exchange information such as delivery quality.

The same data can be delivered to a large number of terminals on the Internet by using an IP (Internet Protocol) multicast technique. Specifically, a single packet transmitted by a delivery server is duplicated at each branch point in a network, and the duplicated packets are delivered to multiple terminals respectively. Thereby, it is possible to perform large-scale streaming delivery to a large number of users, without imposing heavy loads on the delivery server and network, and it is possible to accomplish the efficient use of the band for communication channels.

In IP multicasting, connectionless communication is used in general, in which the arrival of a packet is not confirmed. Therefore, it is necessary to estimate degradation in delivery quality due to packet loss, delay, jitter, and the like. In networks, the high-quality transport of streaming traffic has become commonplace by virtue of CDN (Contents Delivery Network) technology and the like. However, there still remains a possibility of quality degradation in an access network in which physical lines with high bit error rate, such as ADSL (Asymmetric Digital Subscriber Line), VDSL (Very-high-speed Digital Subscriber Line), or the like, are used. Therefore, there is a high need to measure delivery quality for each receiver. Generally, in a best-effort communication network such as the Internet, the management of delivery quality for each receiver is needed because the occurrence of packet loss along a communication path is expected.

However, in the case of using a control protocol such as RTCP, for a delivery server to directly collect delivery quality from a receiving terminal, the delivery server needs to receive a RTCP packet from every receiving terminal. Therefore, the reception load on the server increases with the number of receiving terminals. Accordingly, in the case of large-scale streaming delivery, it is difficult to achieve efficient quality measurement, resulting in a limit to the number of deliveries arising.

### SUMMARY OF THE INVENTION

An exemplary object of the present invention is to provide a quality measurement system and a quality measurement method that enables the management of delivery quality for each communication terminal receiving data packets during packet delivery, without increasing traffic.

According to the present invention, a system for measuring delivery quality of data packets transmitting from a communication device to at least one communication terminal through a multicast network, includes: a communication section for periodically transmitting a first packet to a communication terminal and receiving a second packet in response to the first packet from the communication terminal, wherein the second packet includes delivery quality information; and a measuring section for measuring the delivery quality of data packets based on the delivery quality information.

According to the present invention, it is possible to efficiently collect delivery quality from every receiving terminal during packet delivery, without increasing the traffic between the communication terminal and the communication device. Accordingly, it is possible to manage delivery quality for each packet receiving terminal, without increasing loads on a delivery server and network.

### BRIEF DESCRIPTION OF THE DRAWINGS

FIG. 1 is a block diagram showing an example of the architecture of a quality measurement system according to an exemplary embodiment of the present invention.

FIG. 2A is a block diagram showing an example of the configuration of a subscriber accommodation router in FIG. 1.

FIG. 2B is a block diagram showing an example of a reception statistical information storage section of the subscriber accommodation router.

FIG. 3A is a block diagram showing an example of the configuration of a subscriber terminal according to the exemplary embodiment of the present invention.

FIG. 3B is a block diagram showing an example of a reception statistical information storage section of the subscriber terminal.

FIG. 4 is a diagram showing a format of a query packet used in the quality measurement system according to the exemplary embodiment of the present invention.

FIG. 5 is a diagram showing a format of a multicast group membership report packet used in the quality measurement system according to the exemplary embodiment of the present invention.

FIG. 6 is a sequence chart showing the operation of the quality measurement system according to the exemplary embodiment of the present invention.

FIG. 7 is a diagram showing a structure for quality records used in the quality measurement system according to the exemplary embodiment of the present invention.

FIG. 8 is a block diagram showing an example of the architecture of a quality measurement system according to another exemplary embodiment of the present invention.

### DETAILED DESCRIPTION OF THE PREFERRED EMBODIMENTS

### 1. First Embodiment

### 1.1) System

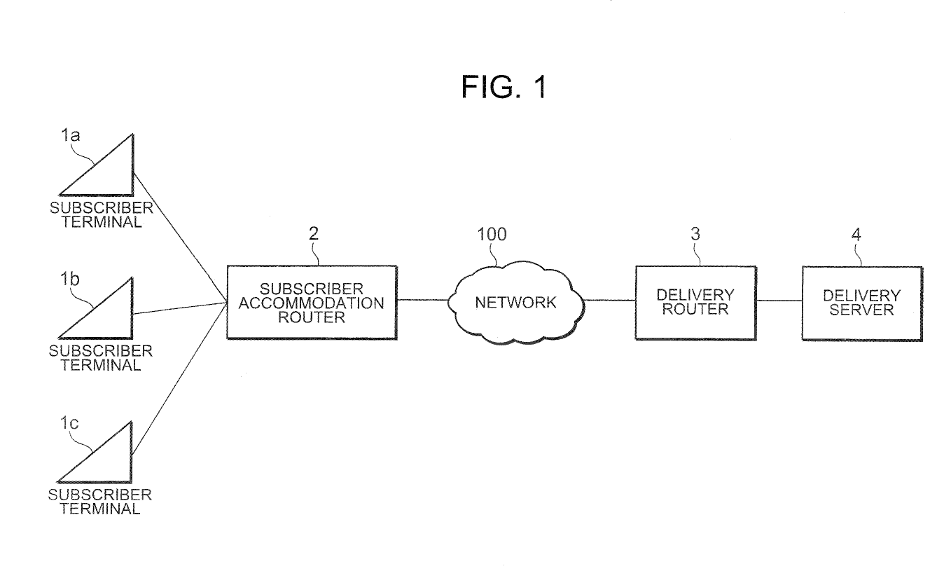

Referring to FIG. 1, a quality measurement system according to a first exemplary embodiment has a network architecture in which multiple subscriber terminals 1a to 1c to receive a streaming delivery are accommodated to a subscriber accommodation router 2, which is connected to a delivery server 4 through a network 100 and a delivery router 3. The network 100 can include one router or more. The delivery server 4 is accommodated to the delivery router 3 and delivers streaming packets to the subscriber terminals 1a to 1c by multicasting. A router is a routing device, which may be also called a switch.

Note that between the subscriber terminals 1a to 1c and the subscriber accommodation router 2, a multi-step layer-2 switch, a metallic access system such as an ADSL/VDSL system, an optical access system such as a PON (Passive Optical Network) may be inserted, which is not particularly described in this embodiment though.

As described below, the subscriber accommodation router 2 sends a periodic query about multicast delivery to every one of the subscriber terminals 1a to 1c. In response to the query received from the subscriber accommodation router 2, the subscriber terminals 1a to 1c, which are currently members of a multicast group, each send a group membership report with delivery quality information added thereto to the subscriber accommodation router 2.

The subscriber accommodation router 2 that has received the group membership reports updates routing information in accordance with a routing protocol and also measures the quality of the delivery between the subscriber accommodation router 2 and each of the subscriber terminals 1a to 1c. The subscriber accommodation router 2 measures the delivery quality by comparing the delivery quality information sent back from the subscriber terminals 1a to 1c with quality information managed in it, which will be described in more detail later.

### 1.2) Subscriber Accommodation Router

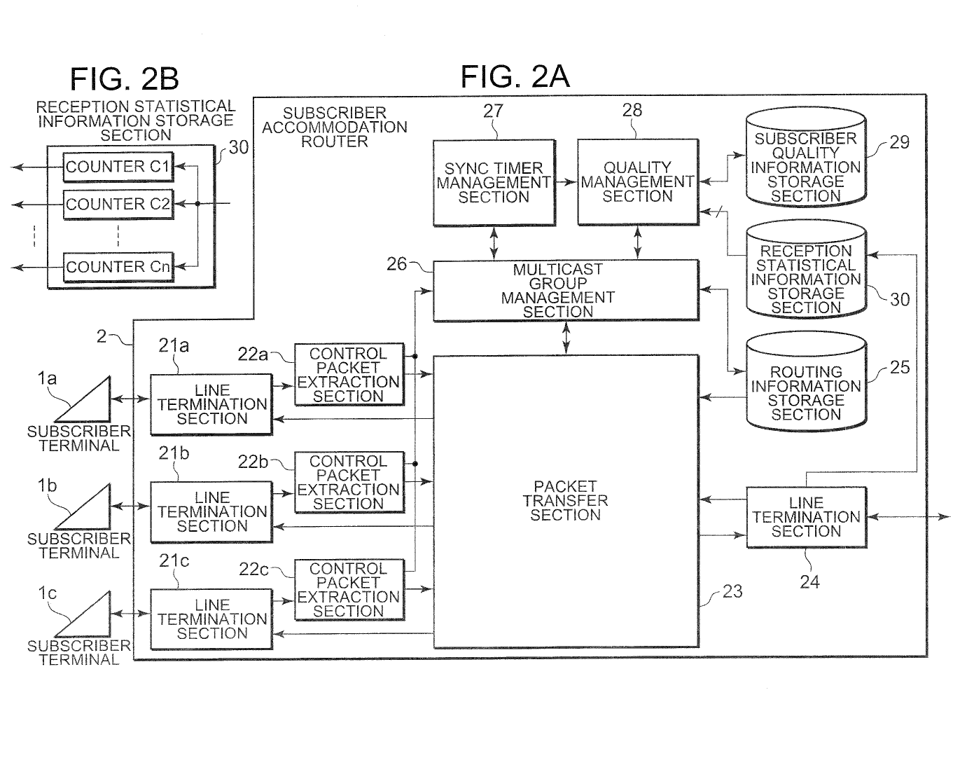

Referring to FIG. 2A, the subscriber accommodation router 2 includes line termination sections 21a to 21c for accommodating the multiple subscriber terminals la to lo respectively, control packet extraction sections 22a to 22c, a packet transfer section 23, a line termination section 24 connected to the network 100, a routing information storage section 25, a multicast group management section 26, a sync timer management section 27, a quality management section 28, a subscriber quality information storage section 29, and a reception statistical information storage section 30.

Note that a typical example of a multicast routing protocol to run between the subscriber accommodation router 2 and each of the subscriber terminals 1a to 1c includes IPv4 IGMP (Internet Group Management Protocol) (see RFC 1112, RFC 2236, etc.) or IPv6 MLD (Multicast Listener Discovery) (see RFC 2710, etc.).

In an application of this embodiment, a protocol to be used is not particularly limited to these protocols. However, in this exemplary embodiment, for simplicity, the description hereinafter is assumed to be given of the case where IGMPv2 is used. In addition, a method for transporting unicast packets will not be particularly described in this embodiment, on the premise that the unicast packet transport is implemented based on the very basic operational concepts of router equipment.

The line termination sections 21a to 21c accommodate the subscriber terminals 1a to 1c set in respective subscriber premises, through optical fiber, twisted pair cable, or the like, and implement the functions of the layers 1 and 2, such as frame synchronization and error control. Each line termination section may be composed of a PHY (physical layer) device and MAC (Media Access Control) device conforming to a standard such as Ethernet™.

When the subscriber accommodation router 2 and the subscriber terminals 1a and 1c operate the multicast routing protocol, the control packet extraction sections 22a to 22c each extract the relevant packet and transfer it to the multicast group management section 26. In the case of the IGMP protocol, the extraction of a control packet is implemented by referring to the destination IP address and the protocol type field in the IP header, and can be easily implemented by a hardware circuit.

The line termination section 24 is an interface connected to the network 100 through optical fiber, twisted pair cable, or the like and implements the functions of the layers 1 and 2 such as frame synchronization and error control, similarly to the above-described line termination sections 21a to 21c.

The packet transfer section 23 is a general packet switch that forwards a packet received from any one of the line termination sections 21a, 21b, 21c, and 24, to another one of the line termination sections 21a, 21b, 21c, and 24. In the case where the packet transfer section 23 is composed of a hardware circuit and a packet buffer memory, it is capable of high-speed packet transfer processing.

A list of transfer destination ports corresponding to destination IP addresses is maintained in the routing information storage section 25. The packet transfer section 23, when receiving a multicast packet from the line termination section 24, determines the subscriber terminals 1a to 1c as its transfer destinations by referring to the routing information storage section 25 before duplicating the packet and then transferring the duplicated packets to the corresponding line termination sections 21a to 21c respectively.

The multicast group management section 26 is a block that terminates a multicast routing packet received from each of the subscriber terminals 1a to 1c, and is generally implemented by software. The reception statistical information storage section 30, as shown in FIG. 2B, includes counters C1, C2, . . . , Cn for counting the cumulative number of received packets as quality information for each destination IP address when the line terminal section 24 receives streaming multicast packets from the network 100.

The sync timer management section 27 is a block that performs time synchronization between the subscriber accommodation router 2 and the subscriber terminals 1a to 1c, by using a time synchronization protocol such as NTP (Network Time Protocol) (see RFC 1305, etc.), and is generally implemented by software.

The quality management section 28 measures the quality of the delivery between the subscriber accommodation section 2 and each of the subscriber terminals 1a to 1c by comparing delivery quality information collected from the subscriber terminals 1a to 1c with quality information calculated inside the reception statistical information storage section 30. The result of this measurement is saved by the subscriber quality information storage section 29 for each of the subscriber terminals 1a to 1c.

### 1.3) Subscriber Terminal

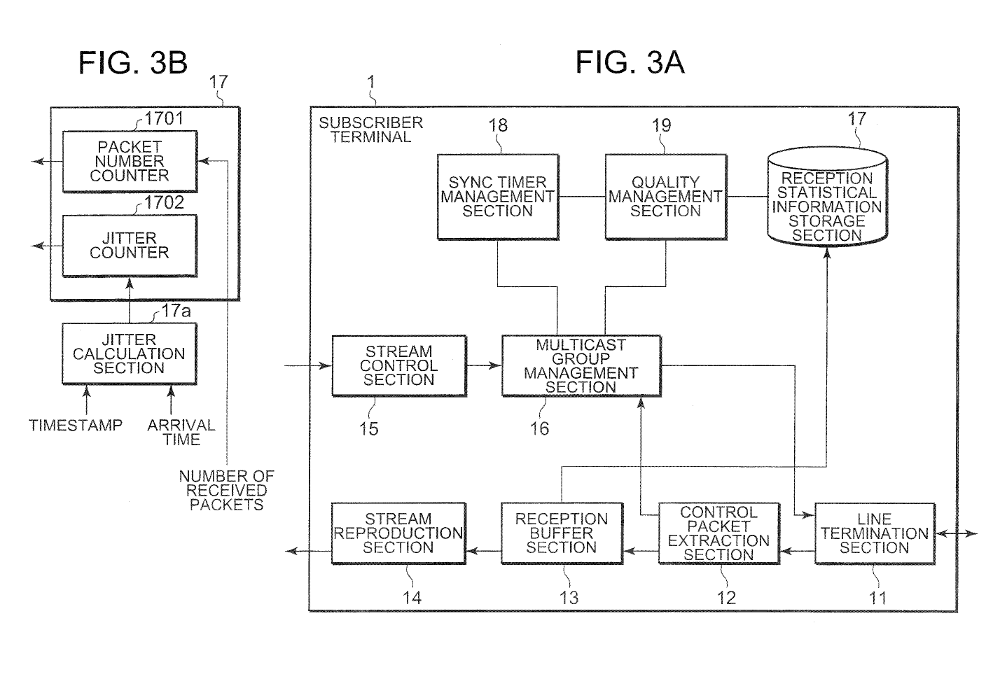

Referring to FIG. 3A, a subscriber terminal 1 includes a line termination section 11, a control packet extraction section 12, a reception buffer section 13, a stream reproduction section 14, a stream control section 15, a multicast group management section 16, a reception statistical information storage section 17, a sync timer management section 18, and a quality management section 19. Note that each of the subscriber terminals 1a to 1c shown in FIG. 1 has substantially the same configuration as this subscriber terminal 1.

The line termination section 11 is an interface connected to the subscriber accommodation router 2 through optical fiber, twisted pair cable, or the like and implements the functions of the layers 1 and 2 such as frame synchronization and error control, similarly to the above-described line termination sections 21a, 21b, 21c, and 24.

The control packet extraction section 12, when the subscriber terminal 1 and the subscriber accommodation router 2 operate the multicast routing protocol, extracts the relevant packet and transfers it to the multicast group management section 16. In the case of the IGMP protocol, the extraction of a control packet can be performed by referring to the destination IP address and the protocol type field in the IP header.

The reception buffer section 13 is a buffer memory in which streaming packets received from the delivery server 4 are stored. Moreover, the stream reproduction section 14 terminates the UDP (User Datagram Protocol) and RTP (Real-Time Transport Protocol) layers of the received packets and assembles a stream, as well as terminating audio/video CODEC (Compression/DECompression) and reproducing multimedia content such as video.

The stream control section 15 determines a multicast group address that a user wishes to join, in accordance with an input operation of the user or the like, and sends a membership report (JOIN/LEAVE request) to this group address through the multicast group management section 16. The multicast group management section 16 terminates a multicast routing packet received from the subscriber accommodation router 2.

The reception statistical information storage section 17, as shown in FIG. 3B, includes a packet number counter 1701 and a jitter counter 1702. The jitter counter 1702 counts as quality information a jitter value calculated by a jitter calculation section 17a. The packet number counter 1701 counts the cumulative number of streaming multicast packets stored in the reception buffer section 13. The jitter calculation section 17a calculates a jitter value from the timestamp field in the RTP header and the arrival intervals of received packets, and outputs the calculated jitter value to the jitter counter 1702. The jitter calculation section 17a may be implemented by a microprocessor (CPU) in the subscriber terminal 1.

The sync timer management section 18 performs time synchronization between the subscriber terminal 1 and the subscriber accommodation router 2 by using a time synchronization protocol such as NTP. The quality management section 19 performs the control for notifying the quality information counted inside the reception statistical information storage section 17, when receiving a query from the subscriber accommodation router 2.

### 1.4) Operation

Hereinafter, an operation of the quality measurement system according to the first exemplary embodiment of the present invention will be described with reference to FIGS. 1 to 6. In the following description, the subscriber terminals 1a to 1c are expressed as the subscriber terminal 1.

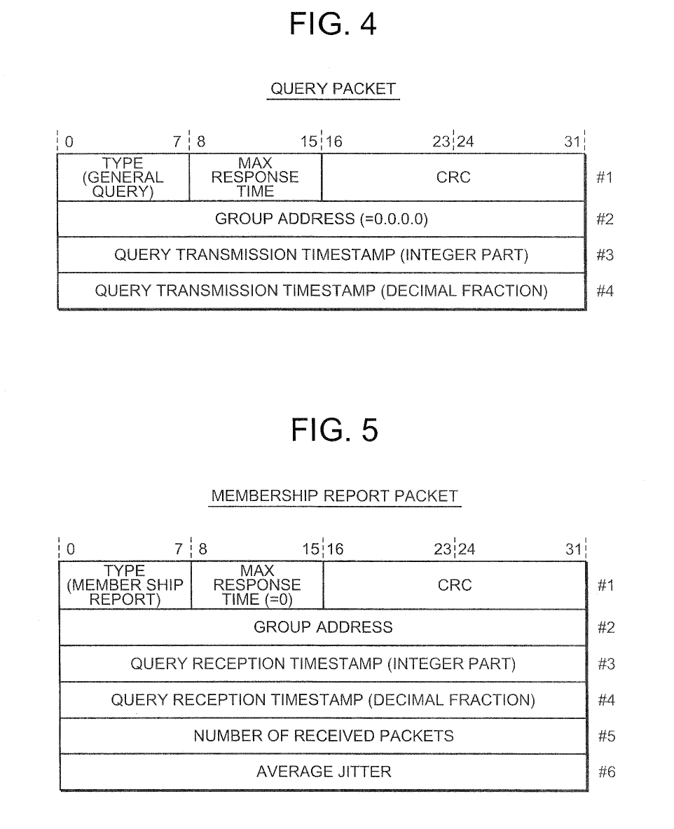

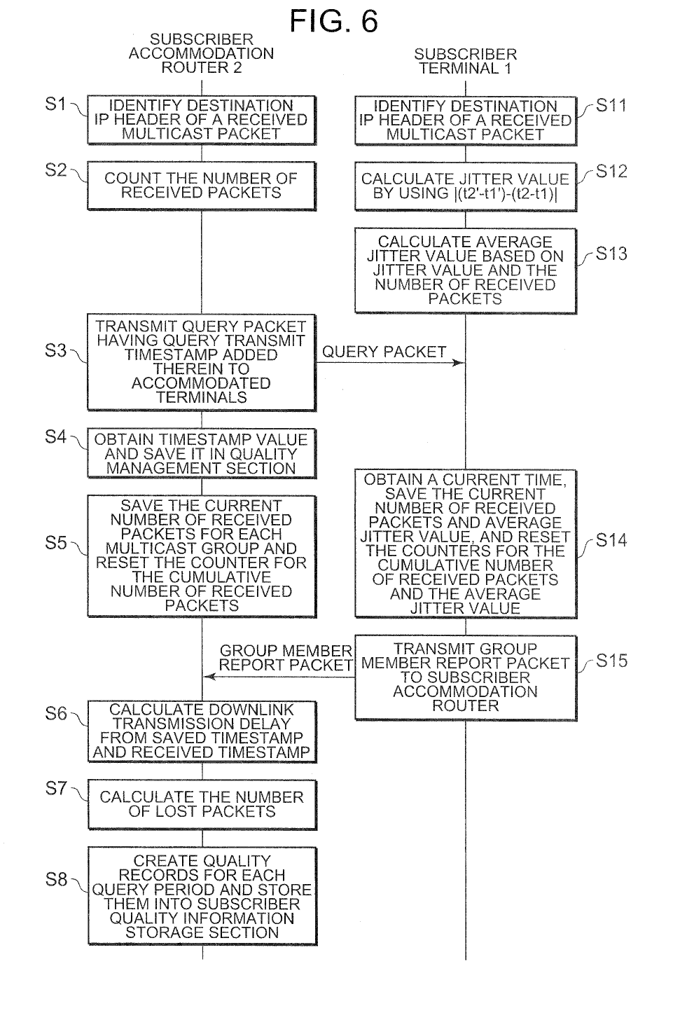

Referring to FIGS. 4 and 5, according to this exemplary embodiment, a query transmission timestamp (#3 and #4 words in FIG. 4) is given in a query packet transmitted by the subscriber accommodation router 2, in the case of a standard IGMPv2 packet. Moreover, a query reception timestamp, the number of received packets, and an average jitter (#3 to #4, #5 and #6 words in FIG. 5, respectively) are given in a group membership report packet transmitted by the subscriber terminal 1, in the case of a standard IGMPv2 packet.

First, description will be given of the operation performed when streaming multicast packets are received. Referring to FIG. 6, when the subscriber accommodation router 2 receives a multicast packet, the line termination section 24 identifies the destination IP header of the received packet (step S1), and the reception statistical information storage section 30 counts the cumulative number of received packets by using the counter corresponding to the destination IP address (step S2).

Similarly, when the subscriber terminal 1 receives a multicast packet from the subscriber accommodation router 2, the reception buffer section 13 stores the received packet from which the destination IP header is identified (step S11). Subsequently, the packet number counter 1701 of the reception statistical information storage section 17 counts the cumulative number of received packets. The jitter calculation section 17a calculates a jitter value from an arrival time t1′ and a RTP header timestamp value t1 of the immediately preceding packet, and an arrival time t2′ and a RTP header timestamp value t2 of the current packet, by using the following equation:

Jitter value=|(t2′−t1′)−(t2−t1)|.

### The calculated jitter value is counted by the jitter counter 1702 (step S12).

Here, the arrival times t1′ and t2′ are values obtained from the sync timer management section 18. Additionally, the quality management section 19 of the subscriber terminal 1 calculates an average jitter value by using the jitter value counted by the jitter counter 1702 and the number of received packets counted by the packet number counter 1701 (step S13).

Next, description will be given of the operation performed when a query timer, which counts a query period according to the IGMP protocol, has expired. The quality management section 28 of the subscriber accommodation router 2 transmits a quality packet with a query transmission timestamp given thereto to every subscriber terminal 1 accommodated to the subscriber accommodation router 2, through the multicast group management section 26 and packet transfer section 23 (step S3).

The query transmission timestamp is obtained from the sync timer management section 27. Assuming that t is the value of a query transmission timestamp, this timestamp value t is saved by the quality management section 28 (step S4). In this exemplary embodiment, it is assumed that the most significant 32 bits of the timestamp value t are represented by an integer part (unit: second) and the least significant 32 bits are represented by a decimal fraction (unit: microsecond), and that the timestamp value t is expressed by a relative value with reference to 0000 hours on Jan. 1, 1900.

The quality management section 28 saves the current cumulative number of received packets, m, received from the reception statistical information storage section 30, for each multicast group and resets the counter counting the cumulative number of received packets (step S5).

Next, description will be given of the operation performed when the subscriber terminal 1 receives a query packet. When the line termination section 11 of the subscriber terminal 1 receives a query packet, a notification to that effect is sent to the sync timer management section 18 via the control packet extraction section 12 and multicast group management section 16. Upon this notification, the quality management section 19 obtains from the sync timer management section 18 a time t′ at which the query packet is received (query reception timestamp). Further, the quality management section 19 saves the current cumulative number of received packets, m′, and the average jitter value, n′, received from the counters 1701 and 1702 of the reception statistical information storage section 17 respectively, and then resets the counters 1701 and 1702 (step S14).

Thus, the quality management section 19 generates a group membership report packet with the query reception timestamp t′, number of received packets m′, and average jitter value n′ given thereto, and controls the multicast group management section 16 so that the generated group membership report packet is transmitted from the line termination section 11 to the subscriber accommodation router 2 (step S15).

When the subscriber accommodation router 2 receives the group membership report packet from the subscriber terminal 1, the corresponding control packet extraction section 22a, 22b or 22c extracts data from this packet and outputs it to the multicast group management section 26. The multicast group management section 26 reads the query reception timestamp t′, number of received packets m′, and average jitter value n′ from the data of the group membership report packet and outputs the read values to the quality management section 28.

The quality management section 28 calculates a downlink transmission delay from the query transmission timestamp value t that has been stored and the reception timestamp value t′ that is reported from the subscriber terminal 1, by using the following equation (step S6):

Downlink transmission delay=t′−t.

Similarly, the quality management section 28 calculates the number of lost packets from the cumulative number of received packets m that has been saved from the reception statistical information storage section 30 and the number of received packets m′ that is reported from the subscriber terminal 1, by using the following equation (step S7):

Number of lost packets=m−m′.

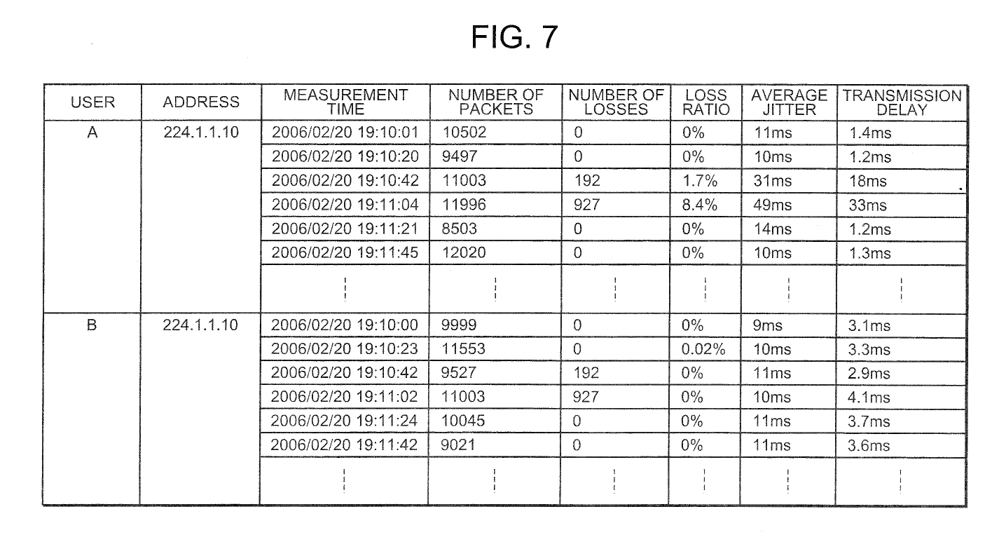

For each user, in every query period, the quality management section 28 generates quality records, including the cumulative number of received packets m, calculated number of lost packets, loss ratio (the number of lost packets divided by m), average jitter value n′ reported from the subscriber terminal 1, and the calculated transmission delay, and stores them in the subscriber quality information storage section 29 (step S8). FIG. 7 is a diagram showing an example of the quality records stored in the subscriber quality information storage section 29.

### 1.5) Advantages

As described hereinabove, according to the first exemplary embodiment, the subscriber accommodation router 2 periodically transmits a query packet in accordance with IGMP, and the subscriber terminal 1, in response to the query packet, sends back a group membership report packet bearing quality information. Thereby, the subscriber accommodation router 2 can easily collect the quality information on each subscriber terminal 1 as shown in FIG. 7, neither affecting the transmission/reception processing performed by software, nor increasing loads on the network. In particular, functionality installation in the subscriber accommodation router 2 and subscriber terminal 1 can be implemented only with the software and hardware frameworks in the existing router and terminal. Accordingly, the advantage can be obtained that the equipment costs are only marginally affected.

Moreover, according to the first exemplary embodiment, an increase in the packet length due to the format extension shown in FIGS. 4 and 5 is ten plus a few bytes at most and only has a slight influence on an entire IGMP packet including the MAC (Media Access Control) and IP headers. Therefore, the advantage can be also obtained that the line bandwidth is only marginally affected as well.

### 2. Second Embodiment

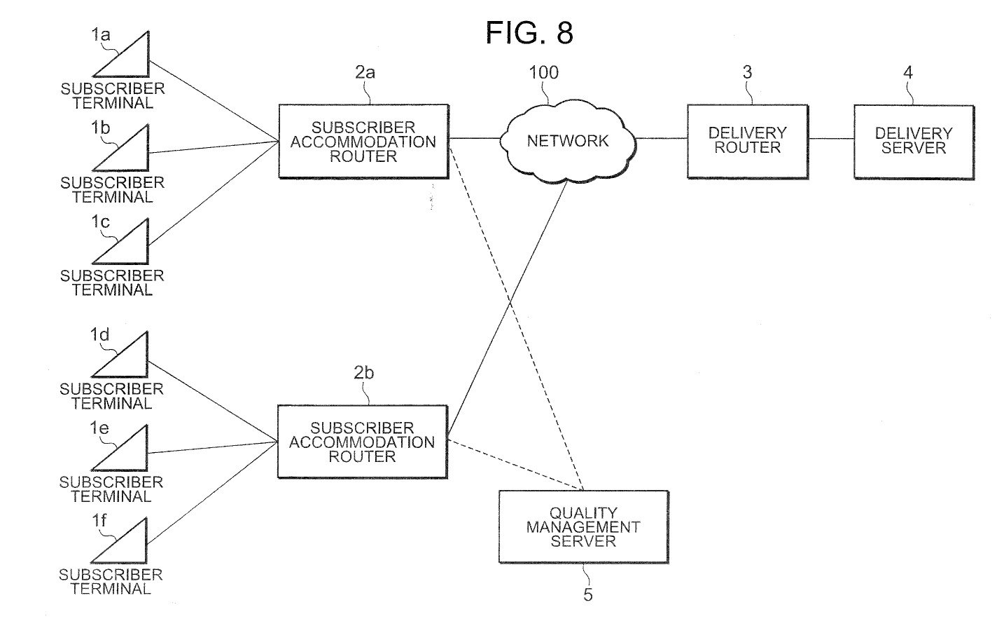

Referring to FIG. 8, a quality measurement system according to another exemplary embodiment of the present invention includes a plurality of subscriber accommodation routers 2 (here, 2a and 2b) and a quality management server 5 that collectively manages the subscriber quality information for the plurality of subscriber accommodation routers 2. Except these points, the quality measurement system according to this exemplary embodiment has an architecture similar to that of the quality management system according to the first embodiment shown in FIG. 1, and the same or equivalent components as in FIG. 1 are given the same reference numerals and symbols as in FIG. 1. In addition, the same or equivalent components operate as in the first embodiment of the present invention.

In this second exemplary embodiment, the subscriber accommodation router 2a accommodates subscriber terminals 1a to 1c, and the subscriber accommodation router 2b accommodates subscriber terminals 1d to 1f. Each of the subscriber accommodation routers 2a and 2b basically has a configuration similar to the subscriber accommodation router 2 shown in FIG. 2. The quality management server 5 is connected to each of the subscriber accommodation routers 2a and 2b through a network (which may be the network 100) and can collect subscriber quality information stored in the subscriber quality information storage section 29 of each of the subscriber accommodation routers 2a and 2b. The subscriber management server 5 can collectively manage the subscriber quality information by collecting the respective quality records on the subscriber terminals 1a to 1f from each subscriber accommodation router as described above.

As described above, according to the present invention, it is possible to efficiently collect the quality of a delivery received at every subscriber terminal (1, 1a to 1f) to which the streaming delivery is being carried out, without increasing the traffic between the subscriber terminal (1, 1a to 1f) and the subscriber accommodation router (2a, 2b). In addition, according to the present invention, the effect is also expected that the implementation can be easily accomplished without affecting other equipment such as the delivery server 4 and delivery router 3.

### 3. Various Exemplary Aspects

A communication device according to an exemplary aspect of the present invention, which delivers packets to a communication terminal on a multicast network, includes: means for periodically exchanging a routing packet between the communication device and the communication terminal; and means for measuring delivery quality between the communication device and the communication terminal based on delivery quality information added to a routing packet received from the communication terminal.

A communication terminal according to an exemplary aspect of the present invention, which receives packets from a communication device on a multicast network, includes: means for adding delivery quality information to a routing packet exchanged between the communication device and the communication terminal and transmitting it back to the communication device, wherein the communication device measures delivery quality with the communication terminal based on the delivery quality information added to the routing packet received from the communication terminal.

A streaming delivery quality measuring method according to an exemplary aspect of the present invention includes: periodically exchanging a routing packet between the communication device and the communication terminal; and measuring delivery quality between the communication device and the communication terminal based on delivery quality information added to a routing packet received from the communication terminal.

As described above, the quality measuring system is a communication system for large-scale streaming delivery using IP (Internet Protocol) multicasting, wherein by adding delivery quality information to a routing packet exchanged between the communication device and the communication terminal, delivery quality information for each subscriber can be collected with high efficiency and cost-effectiveness.

More specifically, a subscriber accommodating router transmits a periodic query of multicast delivery to all subscriber terminals the subscriber terminal jointed to the multicast group packet, in response to the query received from the subscriber accommodating router, transmits a group member report having delivery quality information added thereto back to the subscriber accommodating router. When receiving the group member report from the subscriber terminal, the subscriber accommodating router updates its routing information depending on the routing protocol and compares the delivery quality information received from the subscriber terminal with the quality information counted in the subscriber accommodating router to measure the delivery quality between the subscriber accommodating router and the subscriber terminal.

According to the above-described quality measuring system, it is possible to efficiently collect delivery quality from every subscriber terminal during packet streaming delivery, without increasing the traffic between the subscriber terminal and the subscriber accommodating router.

In other words, the subscriber accommodation router periodically transmits a query packet in accordance with IGMP, and the subscriber terminal, in response to the query packet, sends back a group membership report packet bearing the delivery quality information. Thereby, the subscriber accommodation router can easily collect the quality information on each subscriber terminal neither affecting the transmission/reception processing performed by software, nor increasing loads on the network. In particular, functionality installation in the subscriber accommodation router and subscriber terminal can be implemented only with the software and hardware frameworks in the existing router and terminal.

Further, an increase in the packet length due to the format extension is ten plus a few bytes at most and only has a slight influence on an entire IGMP packet including the MAC and IP headers. Therefore, the advantage can be also obtained that the line bandwidth is only marginally affected as well.

Moreover, in the case where a plurality of subscriber accommodation routers and a quality management server are provided in the system, the quality management server is connected to each of the subscriber accommodation routers through a network and can collect subscriber quality information stored in each of the subscriber accommodation routers. Accordingly, the subscriber management server can collectively manage the subscriber quality information by collecting the respective quality records on the subscriber terminals from each subscriber accommodation router as described above.

The present invention may be embodied in other specific forms without departing from the spirit or essential characteristics thereof. The above-described exemplary embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A system for measuring delivery quality of data packets transmitting from a communication device to at least one communication terminal through a multicast network, comprising:
a communication section for periodically transmitting a first packet to a communication terminal and receiving a second packet in response to the first packet from the communication terminal, wherein the second packet includes delivery quality information; and
a measuring section for measuring the delivery quality of data packets based on the delivery quality information.

2. The system according to claim 1, wherein the delivery quality information is created in the communication terminal based on the data packets and the first packet which are received from the communication device.

3. The system according to claim 2, wherein the measuring section measures the delivery quality of data packets based on information related to transmission and reception of the first packet.

4. The system according to claim 3, wherein the delivery quality information includes reception time information of the first packet at the communication terminal, wherein the measuring section measures a downlink transmission delay by comparing the reception time information at the communication terminal and transmission time information at the communication device.

5. The system according to claim 2, wherein the measuring section measures the delivery quality of data packets based on information related to transmission and reception of the data packets.

6. The system according to claim 5, wherein the measuring section measures the delivery quality of data packets based on count information of the data packets at both of the communication device and the communication terminal.

7. The system according to claim 5, wherein the measuring section measures the delivery quality of data packets based on time information of the data packets at the communication terminal.

8. The system according to claim 2, wherein the delivery quality information includes at least one of the reception time of the first packet, the number of data packets received by the communication terminal, and jitter information of the data packets received by the communication terminal.

9. The system according to claim 1, wherein the data packets are transmitted in streaming delivery based on IP (Internet Protocol) multicasting.

10. The system according to claim 1, wherein the first packet is a query packet which is periodically transmitted according to IGMP (Internet Group Management Protocol) and the second packet is a group member report packet as a response to the query packet, wherein the delivery quality information is added to the group member report packet.

11. The system according to claim 10, wherein the communication device transmits the query packet with transmission timestamp added thereto, wherein the communication terminal transmits the group member report packet with reception timestamp of the query packet added thereto, where the group member report packet further includes the number of data packets received by the communication terminal and jitter information of the received data packets.

12. The system according to claim 1, wherein the communication terminal is a subscriber terminal and the communication device is a routing device, wherein the subscriber terminal is accommodated in the routing device.

13. The system according to claim 1, further comprising a quality manager connected to a plurality of communication devices, wherein the quality manager collectively manages delivery quality information of the communication terminal.

14. A communication device for transmitting data packets to at least one communication terminal through a multicast network, comprising:
a communication section for periodically transmitting a first packet to a communication terminal and receiving a second packet in response to the first packet from the communication terminal, wherein the second packet includes delivery quality information; and
a measuring section for measuring the delivery quality of data packets based on the delivery quality information.

15. The communication device according to claim 14, wherein the measuring section comprises a comparator for comparing reception time information at the communication terminal and transmission time information at the communication device to measure the delivery quality of data packets, wherein the reception time information at the communication terminal is included in the delivery quality information.

16. The communication device according to claim 14, wherein the measuring section comprises:
a counter for counting the data packets to obtain transmission count information at the communication device; and
a comparator for comparing reception count information at the communication terminal and the transmission count information to measure the delivery quality of data packets, wherein the reception count information at the communication terminal is included in the delivery quality information.

17. The communication device according to claim 14, wherein the delivery quality information includes at least one of the reception time of the first packet, the number of data packets received by the communication terminal, and jitter information of the data packets received by the communication terminal.

18. The communication device according to claim 14, wherein the data packets are transmitted in streaming delivery based on IP (Internet Protocol) multicasting.

19. The communication device according to claim 14, wherein the first packet is a query packet which is periodically transmitted according to IGMP (Internet Group Management Protocol) and the second packet is a group member report packet as a response to the query packet, wherein the delivery quality information is added to the group member report packet.

20. The communication device according to claim 19, wherein the communication section transmits the query packet with transmission timestamp added thereto, wherein the communication terminal transmits the group member report packet with reception timestamp of the query packet added thereto, where the group member report packet further includes the number of data packets received by the communication terminal and jitter information of the received data packets.

21. A communication terminal for receiving data packets from a communication device through a multicast network, comprising:
a communication section for receiving a first packet from the communication device and transmitting a second packet in response to the first packet to the communication device, wherein the second packet includes delivery quality information; and
a measuring section for measuring the delivery quality information based on the data packets and the first packet which are received from the communication device.

22. The communication terminal according to claim 21, wherein the measuring section comprises a packet counter for counting the data packets received from the communication device to obtain reception count information, wherein the reception count information is included in the delivery quality information.

23. The communication terminal according to claim 21, wherein the measuring section comprises a jitter detector for detecting jitter information based on data packets received from the communication device, wherein the jitter information is included in the delivery quality information.

24. The communication terminal according to claim 21, wherein the communication section obtains reception time information of the first packet, wherein the reception time information is included in the delivery quality information.

25. The communication terminal according to claim 21, wherein the delivery quality information includes at least one of the reception time of the first packet, the number of data packets received by the communication terminal, and jitter information of the data packets received by the communication terminal.

26. A method for measuring delivery quality of data packets transmitting from a communication device to at least one communication terminal through a multicast network, comprising:
at the communication device,
periodically transmitting a first packet to a communication terminal and receiving a second packet in response to the first packet from the communication terminal, wherein the second packet includes delivery quality information; and
measuring the delivery quality of data packets based on the delivery quality information.

27. The method according to claim 26, further comprising:
at the communication terminal,
measuring the delivery quality information based on the data packets and the first packet which are received from the communication device.

28. The method according to claim 27, wherein the delivery quality of data packets is measured based on information related to transmission and reception of the first packet.

29. The method according to claim 28, wherein the delivery quality information includes reception time information of the first packet at the communication terminal, wherein
the method further comprises: comparing the reception time information at the communication terminal and transmission time information at the communication device to obtain a downlink transmission delay.

30. The method according to claim 27, wherein the delivery quality of data packets is measured based on information related to transmission and reception of the data packets.

31. The method according to claim 30, wherein the information includes count information of the data packets at both of the communication device and the communication terminal.

32. The method according to claim 30, wherein the information includes time information of the data packets at the communication terminal.
